(19) United States
(12) Patent Application Publication
(10) Pub. No.: US 2010/0050184 A1
(43) Pub. Date: Feb. 25, 2010

(54) MULTITASKING PROCESSOR AND TASK SWITCHING METHOD THEREOF

(75) Inventors: Tay-Jyi Lin, Kaohsiung County (TW); Pao-Jui Huang, Changhua County (TW); Chih-Wei Liu, Hsinchu City (TW); Shin-Kai Chen, Kaohsiung County (TW); Bing-Shiun Wang, Keelung City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignees: INDUSTRIAL TECHNOLOGY RESEARCH INSTITUTE, Hsinchu (TW); NATIONAL CHIAO TUNG UNIVERSITY, Hsinchu City (TW)

(21) Appl. No.: 12/354,753

(22) Filed: Jan. 15, 2009

(30) Foreign Application Priority Data
Aug. 21, 2008 (TW) 97131980

(51) Int. Cl. G06F 9/46; G06F 13/24; G06F 9/315; G06F 9/30

(52) U.S. Cl. 718/107; 712/228; 710/267; 712/E09.034; 712/E09.023

(57) ABSTRACT

A multitasking processor and a task switching method thereof are provided. The task switching method includes following steps. A first task is executed by the multitasking processor, wherein the first task contains a plurality of switching-point instructions. An interrupt event occurs. Accordingly, the multitasking processor temporarily stops executing the first task and starts to execute a second task. The multitasking processor executes a handling process of the interrupt event and sets a switching flag. After finishing the handling process of the interrupt event, the multitasking processor does not perform task switching but continues to execute the first task, and the multitasking processor only performs task switching to execute the second task when it reaches a switching-point instruction in the first task.

### CROSS-REFERENCE TO RELATED APPLICATION

This application claims the priority benefit of Taiwan application serial no. 97131980, filed Aug. 21, 2008. The entirety of the above-mentioned patent application is hereby incorporated by reference herein and made a part of specification.

### BACKGROUND OF THE INVENTION

1. Field of the Invention

The present invention generally relates to a multitasking processor and a task switching method thereof.

2. Description of Related Art

The standards of communications and multimedia have been constantly updated along with the rapid development of technologies. Accordingly, programmable processors have gradually replaced the conventional application specific integrated circuits (ASIC) and integrated into different embedded systems. In the new generation of communications and multimedia applications, the calculation complexity of multitasking processors tends to be increased in order to provide higher quality images with lower bit rate. In order to meet the requirement of real-time processing (simultaneously executing multiple applications and instantly responding to user's requests, etc) in these communications and multimedia applications, the programmable processors are implemented by adopting the dynamic real-time management capability of the operating systems or micro kernels through time-slicing multitasking.

In a time-slicing multitasking environment, a programmable processor has to switch the operations (or tasks) it executes frequently. Each time when the programmable processor switches tasks, it has to carry out a context switch to save the state (including information of registers and other tasks) of the current task into a stack. Presently, the development of programmable processors tends to increase the number of registers and the word length of each register in order to increase the calculation capability of the programmable processors through data-level parallelism (DLP) and the single instruction multiple data (SIMD) technique.

The micro kernel adopted by most products in the market is a preemptive micro kernel for performing the dynamic real-time management. FIG. 1 is a flowchart illustrating a task switching method for a preemptive micro kernel of a conventional multitasking processor. When an interrupt event occurs (step S101), the micro kernel controls the multitasking processor to temporarily stop all the tasks. Then, in step S102, the contents of those registers required by the interrupt handler are saved (backed up) into a stack. In step S103, a handling process of the interrupt event is performed, and the micro kernel controls the multitasking processor to store stack points and then reschedule all the tasks (including the currently executed task, tasks in a waiting list, and loading-terminated tasks). In step S104, whether there is any task having a higher priority than the currently executed task is determined according to the task rescheduling result. If there is such a task, a complete context switch is performed to allow the multitasking processor to load the task having the higher priority first (step S110). Herein the context switch includes backing up all the execution context of the original task (the contents of the registers) into the stack and then restoring all the execution context of the new task back into the registers. The new task can be executed (step S111) after the context switch is done. If there is no task having a higher priority, the register contents backed up in step S102 are restored back into the registers (step S120) to continue executing the originally executed task (step S121).

FIG. 1A is a timing diagram of FIG. 1 according to the conventional technique. The abscissa in FIG. 1A indicates the time t. In FIG. 1, the preemptive latency time is time T₁₁ and time T₁₂. Referring to FIG. 1A, the multitasking processor executes a first task before time T101. After an interrupt event occurs at time T101, the multitasking processor temporarily stops executing the first task and performs a handling process of the interrupt event (including interrupt handling and task rescheduling) during the period between time T101 and time T102, wherein the task rescheduling reschedules all the tasks in the waiting list.

After the tasks are rescheduled (i.e., after time T102), if the originally executed first task has the highest priority, the multitasking processor continues to execute the first task, while if a task (a second task) has a higher priority than the original task (the first task), the multitasking processor switches tasks to execute the second task and performs context switch during the period between time T102 and time T103. During the context switch, the multitasking processor backs up the execution context of the first task (contents of all the registers) into the stack and then loads the execution context of the second task into the registers. Obviously, the time required by the context switch is determined according to the number of registers and the word length of each register. The current trend for developing programmable multitasking processor tends to increase the time required by context switch (i.e., the period between time T102 and time T103). In FIG. 1A, time T₁ is a preemption latency time which represents the duration from the occurrence of the interrupt event to the complete of the context switch. The multitasking processor starts to execute the second task after the context switch is completed (i.e., at time T103).

The preemption latency time (T1) is a very important factor in a real-time processing system. In a conventional preemptive micro kernel, all the registers (including both used and unused registers), including invalid registers, are backed up when a context switch is performed.

### SUMMARY OF THE INVENTION

The present invention provides a multitasking processor including a processing unit and a switching flag, wherein the multitasking processor is capable of receiving two or more task assignments. The processing unit executes an instruction set containing a switching-point instruction, wherein the instruction set of the multitasking processor comprises a switching-point instruction, and the switching-point instruction is an interrupt event handling instruction corresponding to the switching flag. The processing unit executes a first task having at least one switching-point instruction. When an interrupt event occurs, the processing unit carries out a handling process of the interrupt event to determine whether perform task switching and sets the switching flag according to the determination result. After that, the processing unit continues to execute the first task until it reaches the switching-point instruction. Then, the processing unit checks the switching flag.

The present invention also provides a task switching method for a multitasking processor. The task switching method includes following steps. First, a first task is executed by the multitasking processor. Herein it is assumed that a particular event indicates that the multitasking processor should switch tasks to execute a second task. When this event occurs, the multitasking processor temporarily stops performing the task switching and continues to execute the first task. When the multitasking processor reaches a switching-point instruction in the first task, the multitasking processor switches the tasks to execute the second task.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a task switching method for a preemptive micro kernel of a conventional multitasking processor.

FIG. 1A is a timing diagram of FIG. 1 according to a conventional technique.

FIG. 2A is a flowchart illustrating an interrupt event handling process in a task switching method for a multitasking processor according to an embodiment of the present invention.

FIG. 2B is a flowchart of a task switching method for a multitasking processor according to an embodiment of the present invention.

FIG. 2C is a diagram illustrating the dispositions of switching-point instructions according to an embodiment of the present invention.

FIG. 2D is a timing diagram of a task switching method for a multitasking processor according to an embodiment of the present invention.

FIG. 3 is a block diagram of a multitasking processor according to an embodiment of the present invention.

FIG. 3A is a diagram of a live register table in FIG. 3 according to an embodiment of the present invention.

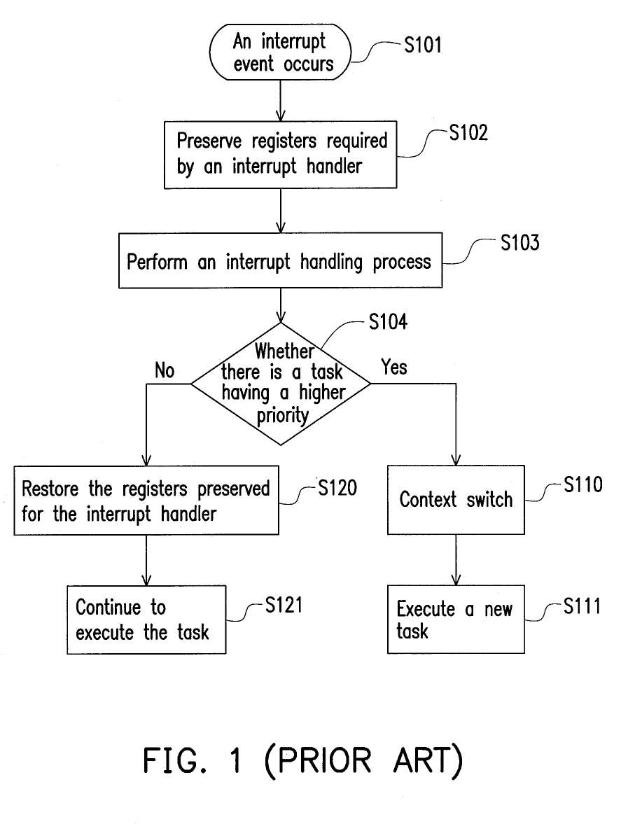

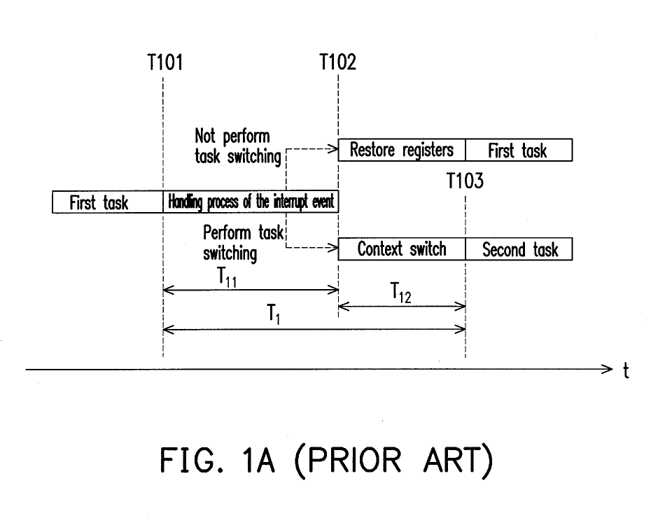

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

As described above, the current design of multitasking processor tends to increase the number of registers and the word length of each register. Accordingly, when a conventional preemptive micro kernel executes multiple tasks through time-slicing multitasking, too much time is spent for backing up all the registers when a task switching is carried out. Thereby, the present invention provides a multitasking processor and a task switching method thereof, wherein a switching-point instruction and a switching flag are adopted. The following embodiments dispose the switching-point instructions at positions in a first task which consume less system resource, the multitasking processor (or the embedded system) can perform task switching (or context switching) at where less system resource is consumed and accordingly relatively less time is spent on the task switching.

How the multitasking processor in the present invention switches its tasks when an event (for example, an interrupt event) occurs will be described with reference to embodiments of the present invention. The aforementioned event indicates that the multitasking processor should perform a “task switch” to switch from the execution of a first task to the execution of a second task.

When the interrupt event occurs, in the present embodiment, the multitasking processor temporarily stops performing the task switching and continues to execute the current task (the first task). The multitasking processor only switches the tasks to execute a new task (the second task) when it reaches a switching point in the first task. The switching point may be a point in the first task which consumes less system resource when the task switching is performed (e.g., less registers are to be preserved). In addition, the switching point may also be a task switching point in the first task which is set for meeting real-time requirements. The switching point can be implemented or inserted through any method by those having ordinary knowledge in the art. For example, a switching-point instruction may be disposed at a position in the first task which consumes less system resource for the task switching to mark the position of the switching point and trigger the “task switch” of the multitasking processor. When the multitasking processor reaches the switching point in the first task and needs to switch the tasks, less registers are to be preserved for backing up the switched context. Thus, in the embodiment, the time and power consumed for switching tasks can be reduced, and the hardware cost (for example, the capacity of the stack) for the multitasking processor to switch between multiple tasks can be reduced.

It should be noted that in the present embodiment and following embodiments of the present invention, the event (or the interrupt event) which can trigger the “task switch” can be any type of event. For example, the event may be a software interrupt event or a hardware interrupt event occurring inside or outside the multitasking processor. Or, the event may also be a timer event occurring periodically. Below, another embodiment of the present invention will be described in detail to explain how the event in the present embodiment is implemented.

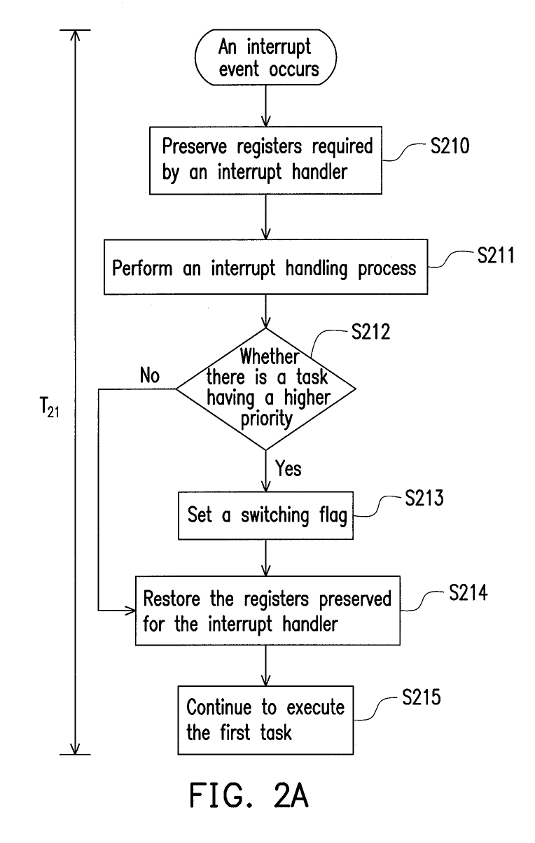

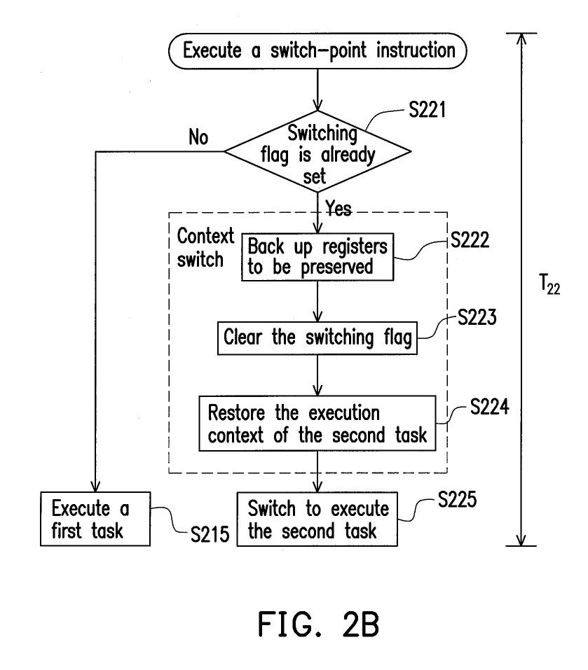

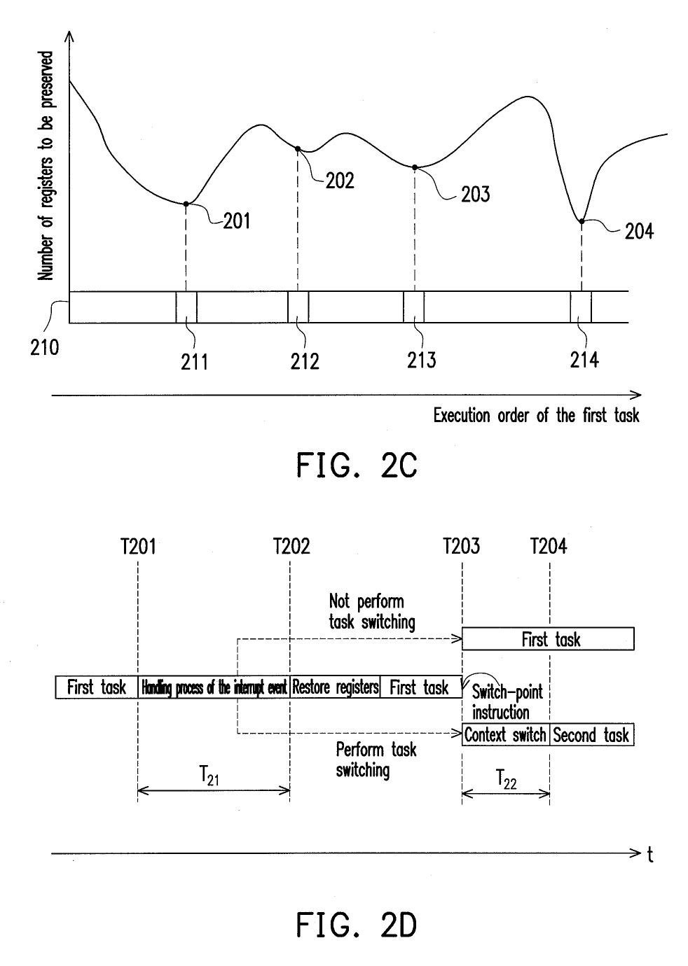

FIG. 2A is a flowchart illustrating an interrupt event handling process in a task switching method for a multitasking processor according to an embodiment of the present invention. FIG. 2B is a flowchart of a task switching method for a multitasking processor according to an embodiment of the present invention. FIG. 2C is a diagram illustrating the dispositions of switching-point instructions according to an embodiment of the present invention. FIG. 2D is a timing diagram of a task switching method for a multitasking processor according to an embodiment of the present invention. The abscissa in FIG. 2D indicates the time t.

Referring to FIG. 2D, the multitasking processor loads and executes a first task before time T201, wherein the first task contains at least one switching-point instruction. The multitasking processor continues to execute the first task if no interrupt event occurs and no switching-point instruction is executed. Referring to both FIG. 2A and FIG. 2D, assuming an interrupt event occurs at time T201 when the first task is executed, the multitasking processor temporarily stops executing the first task and backs up the contents of some registers required by a handling process of the interrupt event (step S210). Next, the handling process of the interrupt event is performed (step S211) and all the tasks (including the currently executed task, tasks in a waiting list, and the task triggering the interrupt event) are rescheduled.

If the result of the task rescheduling operation indicates that the first task has the highest priority (step S212) to be executed, step S214 is directly executed to restore the registers preserved for the handling process of the interrupt event without setting the switching flag. Next, the multitasking processor continues to execute the first task after time T202 (step S215). Contrarily, if the result of the task rescheduling operation indicates that the first task does not have the highest priority (step S212), which means there is a task having higher priority (here the task having the highest priority is assumed to be a second task), the multitasking processor sets the switching flag (step S213) after step S212 is executed. Thereafter, the registers preserved for the handling process of the interrupt event are restored at time T202 (step S214). After that, assuming that no interrupt event occurs and no switching-point instruction in the first task is executed before time T203, the multitasking processor does not perform the task switching and continues to execute the first task (step S215) until it reaches a switching-point instruction in the first task (i.e., at time T203 in FIG. 2D).

Referring to FIG. 2B and FIG. 2D, when the multitasking processor executes the switching-point instruction, the multitasking processor determines whether the context switching (task switching) is performed or not according to the switching flag in step S221. If the multitasking processor does not perform step S213, namely, the switching flag is not set, the multitasking processor continues to execute the first task (step S215). Contrarily, if the multitasking processor has set the switching flag in step S213, the multitasking processor performs a context switch after step S221 and then starts to execute the second task. In other words, when the multitasking processor reaches the switching-point instruction, if the result of the task rescheduling in the handling process of the interrupt event indicates that the multitasking processor needs to perform task switching, the multitasking processor executes the second task after it performs the context switch. In the present embodiment, the context switch includes steps S222, S223, and S224. In step S222, the multitasking processor records a stack point and stores the execution context of the first task into the stack to backup the task execution context. After the backup, the multitasking processor clears the switching flag (step S223) and then loads the execution context of the second task (step S224). The multitasking processor completes the context switch after foregoing operations, and after time T204, the multitasking processor starts to execute the second task (step S225). Meanwhile, the first task is suspended until the next interrupt event occurs or the second task is ended.

The switching-point instruction in the first task may be located at a position which consumes less system resource, namely, the position requires less registers to be preserved when the multitasking processor performs the task switching. Referring to FIG. 2C, the abscissa indicates the execution order of the first task, and the ordinate indicates the number of registers to be preserved when the multitasking processor performs task switching. Generally speaking, the curve in FIG. 2C can be obtained through state analysis by using a programming language compiler. Before disposing switching-point instructions, the program designer can perform static analysis to the program code 210 of the first task by using the compiler so as to obtain the usage of registers by the program code. The registers which will be used are the registers to be preserved when the multitasking processor performs task switching. Next, the compiler can dispose the switching-point instructions at positions in the program code which require the least registers to be preserved (for example, dispose the switching-point instruction 214 at the position 204) according to the result of the static analysis and tests whether the requirement of preemption latency time is met. If the requirement of the preemption latency time is not met, the compiler loosens the limit on the usage of system resources and further analyzes a target section in the program code which contains insufficient switching-point instructions. Then, the compiler disposes the switching-point instruction at an optimal substitute point in the target section, wherein the optimal substitute point is the place in the target section which requires the least registers to be preserved when the multitasking processor switches tasks. As shown in FIG. 2C, the switching-point instructions 211, 212, and 213 are respectively disposed at the positions 201, 202, and 203. Foregoing operations are repeated until the preemption latency time between adjacent two switching-point instructions in the program code of the first task won't be too long. In order to avoid disposing too many switching-point instructions in the program code and accordingly reducing the performance of the first task, eventually the program code is analyzed, and two switching-point instructions having a too short preemption latency time are combined to ensure that there won't be too many switching-point instructions in the compiled first task and the switching-point instructions 211˜214 are respectively disposed at the positions 201˜204 in the target section which require the least number of registers to be preserved.

The switching-point instruction disposition method described above is the first disposition method. Besides, a second switching-point instruction disposition method will be described below. In this second method, first, a switching-point instruction is respectively disposed at the end of each sub program (sub task) in the first task. Because only the operation result of a sub program is kept to be sent to a main program or a next sub program when the sub program is ended, the least number of registers (i.e., system resources) are to be preserved. Next, whether the dispositions of two switching-point instructions meet the restriction in the preemption latency time is tested, and additional switching-point instructions are disposed at optimal substitute points according to the testing result. The testing method used here is the same as that in foregoing disposition method therefore will not be described herein.

However, the end of a sub program may not require the least number of registers to be preserved. Thus, foregoing method can be altered to meet the restriction on the preemption latency time. The third method for disposing switching-point instructions is to perform static analysis to each sub program and dispose the switching-point instruction at a position which requires the least number of registers to be preserved, wherein the position may not be at the end of the sub program. Then, a latency time test is performed to the entire program to determine whether the disposed positions of the switching-point instructions and the density thereof meet the restriction on the latency time. If the disposed positions of the switching-point instructions and the density thereof do not meet the restriction on latency time, switching-point instructions are further disposed through the method described above. In another embodiment of the present invention, the switching-point instructions may also be disposed through a combined method of foregoing first, second, and third methods or other suitable methods. For example, the switching-point instructions may also be task switching points disposed in the first task for meeting real-time requirements.

As described above in foregoing embodiments, if an interrupt event occurs when a multitasking processor provided by the present invention executes a first task, the multitasking processor pauses the execution of the first task and executes a handling process of the interrupt event. Thereby, the fast processing capability of interrupt event is kept in the present invention.

As described in foregoing embodiments, because the switching-point instructions are disposed at positions in the first task which consume less system resource, the multitasking processor provided by the present invention can perform task switching at where less system resource is consumed and accordingly relatively less time is spent on the task switching.

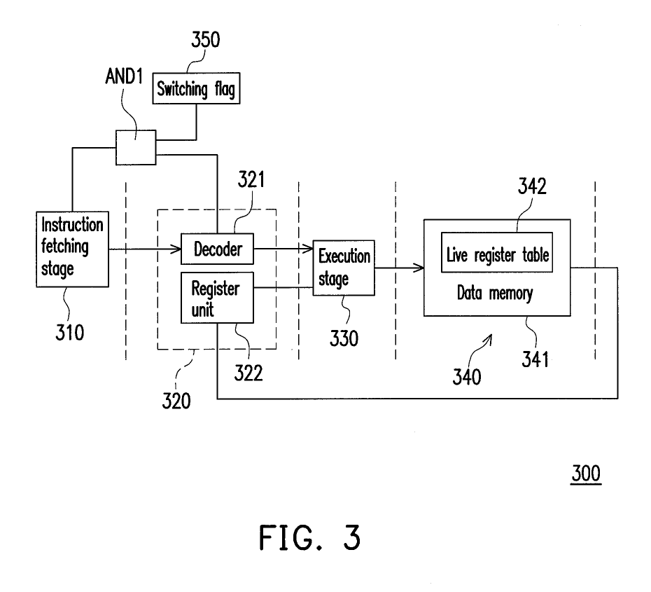

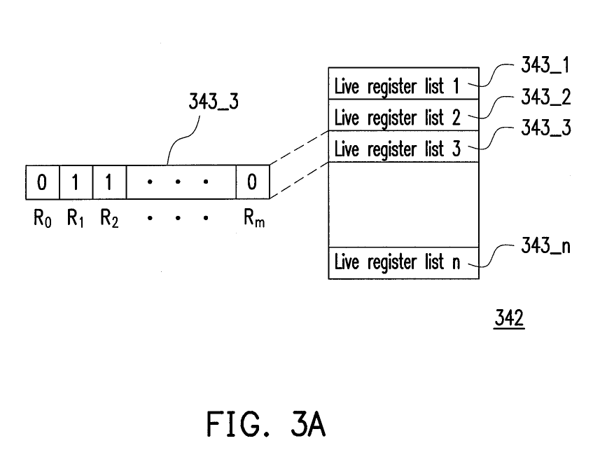

FIG. 3 is a block diagram of a multitasking processor 300 according to an embodiment of the present invention. Referring to FIG. 3, the multitasking processor 300 includes a processing unit and a switching flag 350. The processing unit executes an instruction set containing a switching-point instruction, wherein the switching-point instruction is a specific processor instruction. The processing unit executes a first task having at least one switching-point instruction corresponding to interrupt event handling. When an interrupt event occurs, the processing unit performs a handling process of the interrupt event to determine whether a task switching is to be performed and sets the switching flag according to the determination result. After that, the processing unit continues to execute the first task until it reaches the switching-point instruction in the first task. Then the processing unit checks the switching flag. If the switching flag indicates that the processing unit determines to perform the task switching when the processing unit performs the handling process of the interrupt event, the processing unit switches the tasks to execute the second task. If the switching flag indicates that the processing unit determines not to perform the task switching when the processing unit performs the handling process of the interrupt event, the processing unit continues to execute the first task.

The processing unit can be implemented through any method by those skilled in the art. For example, the processing unit in FIG. 3 includes an instruction fetching stage 310, an instruction decoding stage 320, an execution stage 330, a data access stage 340, and an AND gate AND1. To simply the figure, not all the components or signal paths (for example, control/set signal path) are illustrated in FIG. 3. The instruction fetching stage 310 sequentially obtains instructions from the program code of a task and sends the instructions to the instruction decoding stage 320 to be decoded. After that, the decoded instructions are sent to the execution stage 330 to be executed.

The instruction decoding stage 320 includes a decoder 321 and a register unit 322. The decoder 321 decodes the instructions to allow the execution stage 330 to operate according to the instructions. According to the decoding result of the decoder 321, the operands are sent from the register unit 322 to the execution stage 330 to be calculated. After that, the execution stage 330 writes the calculation result back to the register unit 322 or back into a data memory 341 through the data access stage 340 according to the decoding result of the decoder 321.

In the present embodiment, first, the instruction fetching stage 310 sequentially obtain each instruction in the program code of the first task, wherein a plurality of switching-point instructions have been disposed in the program code of the first task, and the method for disposing these switching-point instructions can be referred to FIG. 2C and the related description thereof therefore will not be described herein. The instruction obtained by the instruction fetching stage 310 is decoded by the decoder 321 and then sent to the execution stage 330 to be executed.

In the present embodiment, the multitasking processor has to back up different execution context when the multitasking processor performs task switching at each switching point in the first task. In the present embodiment, an exclusive live register list is established corresponding to each switching-point instruction for recording the registers to be backed up when the multitasking processor switches tasks. Each switching-point instruction contains an address, and this address points to the live register list corresponding to the switching-point instruction. All the live register lists are recorded in a live register table 342.

In the present embodiment, the live register table 342 is disposed in the data memory 341. The live register table 342 can be implemented through any method by those skilled in the art. FIG. 3A is a diagram of the live register table 342 according to an embodiment of the present invention. Referring to FIG. 3A, because the execution context to be preserved at each switching point is different, a plurality of live register lists 343 (for example, the live register lists 343_1˜343_{—}n in FIG. 3A) has to be established for recording the information of registers to be preserved for each switching-point instruction. For example, in FIG. 2C, the information of registers to be preserved for the switching-point instruction 211 is recorded in the live register list 343_1 in FIG. 3A, the information of registers to be preserved for the switching-point instruction 212 is recorded in the live register list 342_2 in FIG. 3A, and so on. Taking the live register list 343_3 as an example, the live register list 343_3 records the registers to be backed up (0 means not to be recorded and 1 to be recorded) when the multitasking processor performs task switching and the switching-point instruction 213 is reached (i.e., at the position 203 in FIG. 2C). For example, if the content of the live register list 343_3 is “011 . . . ”, which means the content of the register R0 in the register unit 320 is not to be stored, the content of the register R1 is to be stored, the content of the register R2 is to be stored, and so on. As shown in FIG. 3A, all the live register lists 343_1˜343_{—}n are recorded in the live register table 342, wherein the width m (i.e., the number of registers in the system) and the length n (i.e., the number of switching-point instructions) of the live register table 342 can be determined according to the system environment and the actual design.

As described above, referring to FIG. 3 and FIG. 3A, the instruction fetching stage 310 sequentially obtains instructions in the program code of the first task and sends the instructions to the decoder 321 to be decoded. When the execution stage 330 receives a decoded instruction, the execution stage 330 performs different operation according to the instruction. The register unit 322 includes a plurality of registers for recording the execution context of the multitasking processor 300. As described in foregoing embodiment, if an interrupt event occurs at time T201 when the multitasking processor 300 executes the first task (in the present embodiment, the interrupt event is occurred for triggering a second task), the execution stage 330 executes a handling process of the interrupt event. In the handling process of the interrupt event, the execution stage 330 temporarily stops the execution of the first task and backs up data in some registers in the register unit 322 into the stack (or the data memory 341) to preserve the registers required by the handling process of the interrupt event. Then, the execution stage 330 reschedules all the tasks (step S211). Foregoing handling process of the interrupt event and the task rescheduling process can be implemented through any technique by those skilled in the art. For example, the interrupt handling process and the task rescheduling process can be implemented through conventional techniques.

After the task rescheduling is performed, the multitasking processor 300 checks whether the first task has the highest priority (step S212). If the first task does not have the highest priority, the multitasking processor 300 sets the switching flag 350 (step S213); otherwise, if the first task has the highest priority, the multitasking processor 300 resets or clears the switching flag 350. Foregoing process can be referred to FIG. 2A and the related description thereof. Foregoing steps S211, S212, and S213 can be executed by the instruction decoding stage 320, the execution stage 330, or other control circuits (not shown) in the multitasking processor 300.

Regardless of whether the switching flag is set, the multitasking processor restores the registers preserved for the interrupt handling process (step S214) after the execution stage 330 completes the task rescheduling. After the data is recovered in the register unit 322, the execution stage 330 continues to execute the first task. In other words, after the handling process of the interrupt event is completed, the multitasking processor 300 does not perform task switching but continues to execute the first task until it reaches a switching-point instruction in the first task.

When the instruction fetching stage 310 sends the switching-point instruction in the first task to the decoder 321 (i.e., at time T203 in FIG. 2D), the decoder 321 issues a task switching signal to the AND gate AND1. If the switching flag 350 is not set yet (i.e., the switching flag 350 is logic “0”), the task switching signal issued by the decoder 321 is blocked by the AND gate AND1 therefore cannot reach the instruction fetching stage 310. If the switching flag 350 is already set (i.e., the switching flag 350 is logic “1”), the task switching signal issued by the decoder 321 reaches the instruction fetching stage 310 through the AND gate AND1. Then, the instruction fetching stage 310 determines whether to obtain the next instruction from the program code of the first task or obtain a task switching program instruction to execute the second task according to the task switching signal.

Thus, when the instruction decoding stage 320 executes the switching-point instruction, the multitasking processor 300 continues to execute the first task if the switching flag 350 is not set. Contrarily, when the instruction decoding stage 320 executes the switching-point instruction, the multitasking processor 300 performs context switch (during the period between time T203 and time T204 in FIG. 2D) to execute the second task if the switching flag 350 is already set. During the context switch, the multitasking processor 300 finds the live register list corresponding to the switching-point instruction (here it is assumed to be the live register list 343_3) from the live register table 342 according to the currently executed switching-point instruction. The multitasking processor 300 backs up the live registers in the register unit 322 according to the content of the live register list corresponding to the switching-point instruction and stores the content of these registers into the stack (or the data memory 341). Accordingly, the execution context of the first task in the multitasking processor 300 at time T203 can be backed up (step S222). After that, the multitasking processor 300 clears the switching flag (step S223) and then loads the execution context of the second task (step S224), so as to complete the task switching. Foregoing steps S222, S223, S224, and other operations can be accomplished by the instruction decoding stage 320, the execution stage 330, or other control circuits (not shown) in the multitasking processor 300, and different designs may be adopted according to different requirements.

After the task switching is completed, the instruction fetching stage 310 starts to obtain instructions sequentially from the program code of the second task so that the multitasking processor 300 can start to execute the second task. This process can be referred to FIG. 2B and the related description thereof therefore will not be described herein.

In the embodiment described above, after the multitasking processor completes the handling process of an interrupt event, the multitasking processor does not perform any task switching but continues to execute the first task until it reaches a switching-point instruction in the first task. Since all the switching-point instructions are disposed at positions in the first task which consume less system resource (i.e., less registers are to be preserved), when the multitasking processor reaches the switching-point instruction in the first task and needs to switch the tasks, less registers are to be preserved for backing up the switched context. Even though the performance of the system is slightly affected by disposing the switching-point instructions, the execution time of the entire program won't be affected too much. Thus, in the present embodiment, the time and power consumed for switching tasks can be reduced, and the hardware cost (for example, the capacity of the stack) for the multitasking processor to switch between multiple tasks can be reduced.

It should be noted that the switching flag mentioned in foregoing embodiments can be built in the register unit or additionally set in the multitasking processor. Herein the meaning of “built in the register unit” is that in the present invention, the switching flag may also be accomplished by using the registers and memory space not used by the multitasking processor. Moreover, even though in the embodiment described above, the live register list required by each switching-point instruction is placed in the live register table 342, the implementation thereof is not limited thereto. For example, in another embodiment of the present invention, the live register lists may be encoded into the corresponding switching-point instructions so that the live register lists can be obtained by the instruction fetching stage 310 along with the switching-point instructions and accordingly it is not necessary to obtain the live register list 343 from the data memory 341 additionally.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multitasking processor, capable of receiving two or more task assignments, the multitasking processor comprising:
a switching flag; and
a processing unit, for executing a task formed by an instruction set of the multitasking processor, wherein the instruction set of the multitasking processor comprises a switching-point instruction, and the switching-point instruction is an interrupt event handling instruction corresponding to the switching flag;
wherein the processing unit executes a first task having at least one of the switching-point instruction; when an interrupt event occurs, the processing unit performs a handling process of the interrupt event and determines whether to perform a task switching, and the processing unit sets the switching flag according to the determination result and then continues to execute the first task until the processing unit reaches the switching-point instruction in the first task; and the processing unit determines whether the task switching is performed or not according to the switching flag when the processing unit executes the switching-point instruction.

2. The multitasking processor according to claim 1, wherein if the switching flag is already set, i.e. the processing unit determines to perform the task switching when the handling process of the interrupt event is performed, the processing unit performs the task switching to execute a second task when the processing unit executes the switching-point instruction; and if the switching flag is not set, i.e. the processing unit determines not to perform the task switching when the handling process of the interrupt event is performed, the processing unit continuing to execute the first task when the processing unit executes the switching-point instruction.

3. The multitasking processor according to claim 2 further comprising:
a live register list, for identifying live registers corresponding to the switching-point instruction, wherein the live registers are registers to be backed up when the processing unit reaches the switching-point instruction and performs the task switching; and
a live register table, comprising the live register lists corresponding to the switching-point instructions in the first task.

4. The multitasking processor according to claim 3, wherein the switching-point instruction comprises an address pointing to the live register list corresponding to the switching-point instruction; if the processing unit reaches the switching-point instruction and the switching flag is already set, the processing unit performs the task switching to execute the second task, wherein the task switching comprises storing all live registers according to the live register list corresponding to the switching-point instruction.

5. The multitasking processor according to claim 4, wherein the live register list and the live register table are stored in a data memory.

6. The multitasking processor according to claim 4, wherein the handling process of the interrupt event performed by the processing unit comprises a task rescheduling; wherein if the result of the task rescheduling indicates that the processing unit needs to switch tasks, the processing unit sets the switching flag; and if the result of the task rescheduling indicates that the processing unit does not need to switch tasks, the processing unit resets or clears the switching flag.

7. The multitasking processor according to claim 6, wherein the task rescheduling comprises comparing priorities of the first task and the second task.

8. The multitasking processor according to claim 1, wherein the interrupt event comprises a software interrupt event or a hardware interrupt event occurring inside or outside the multitasking processor.

9. The multitasking processor according to claim 1, wherein the interrupt event comprises a timer event occurring periodically.

10. The multitasking processor according to claim 1, wherein the switching-point instruction is located at the end of a sub task in the first task.

11. The multitasking processor according to claim 1, wherein the switching-point instruction is located at a position in the first task which consumes less system resource for the task switching.

12. The multitasking processor according to claim 1, wherein the switching-point instruction is located at a task switching point set for meeting real-time requirements in the first task.

13. A task switching method for a multitasking processor, comprising:
executing a first task by using the multitasking processor, wherein the first task comprises at least one switching point;
if an interrupt event occurs, continuing to execute the first task by using the multitasking processor after performing a handling process of the interrupt event, so as to determine whether to perform a task switching;
if the result of the handling process of the interrupt event indicates that the multitasking processor needs to perform the task switching, performing the task switching to execute a second task by using the multitasking processor when the multitasking processor reaches the switching point in the first task; and
if the result of the handling process of the interrupt event indicates that the multitasking processor does not need to perform the task switching, continuing to execute the first task by using the multitasking processor when the multitasking processor reaches the switching point in the first task.

14. The task switch method according to claim 13, wherein the handling process of the interrupt event comprises:
performing a task rescheduling; and
determining whether to perform the task switching according to a result of the task rescheduling.

15. The task switch method according to claim 14, wherein the task rescheduling comprises comparing priorities of the first task and the second task.

16. The task switch method according to claim 13, wherein the interrupt event comprises a software interrupt event or a hardware interrupt event occurring inside or outside the multitasking processor.

17. The task switch method according to claim 13, wherein the interrupt event comprises a timer event occurring periodically.

18. The task switch method according to claim 13, wherein the switching point is located at the end of a sub task in the first task.

19. The task switch method according to claim 13, wherein the switching point is located at a position in the first task which consumes less system resource for the task switching.

20. The task switch method according to claim 13, wherein the switching point is located at a task switching point set for meeting real-time requirements in the first task.

21. A task switching method for a multitasking processor, comprising:
executing a first task by using a multitasking processor;
an event occurring, wherein the event indicates that the multitasking processor needs to perform a task switching to switch from the first task to a second task; and
temporarily postponing the task switching and continuing to execute the first task by using the multitasking processor, and performing the task switching to execute the second task by using the multitasking processor when the multitasking processor reaches a switching point in the first task.

22. The task switch method according to claim 21, wherein the event is a software interrupt event or a hardware interrupt event occurring inside or outside the multitasking processor.

23. The task switch method according to claim 21, wherein the event is a timer event occurring periodically.

24. The task switch method according to claim 21, wherein the switching point is located at the end of a sub task in the first task.

25. The task switch method according to claim 21, wherein the switching point is located at a position in the first task which consumes less system resource for the task switching.

26. The task switch method according to claim 21, wherein the switching point is located a task switching point set for meeting real-time requirements in the first task.
